(19) United States
(12) Patent Application Publication
(10) Pub. No.: US 2008/0089988 A1
(43) Pub. Date: Apr. 17, 2008

(54) Confectionery moulding device

(76) Inventor: Kam-Lai Wong, Hong Kong (CN)

Correspondence Address: ALIX YALE & RISTAS LLP, 750 MAIN STREET, SUITE 1400, HARTFORD, CT, 06103, US

(21) Appl. No.: 11/582,736

(22) Filed: Oct. 17, 2006

(51) Int. Cl. A23G 3/02

(52) U.S. Cl. 426/512

(57) ABSTRACT

A confectionery moulding device for making confectionery pieces from a source of flowing confectionery includes a number of trays supported by the frame and positioned one above another, each tray has a number of mould cavities interconnected by flow tracks. At least some of the trays include a drain via which the flowing confectionery material can pass to a tray underneath.

### BACKGROUND OF THE INVENTION

The present invention relates to a device to mould confectionery pieces such as candy or chocolate pieces. More particularly, although not exclusively, the invention relates to a confectionery maker that can be used in the home to make moulded candy or chocolate pieces for example.

Confectionery factories mass-produce candy and chocolate pieces in large-scale moulds.

It is also known to make homemade confectionery using a mould tray in which a number of mould cavities are provided. These cavities are individually filled with soft (sometimes preheated) confectionery material and allowed to set for later removal. This is a time-consuming process.

### OBJECTS OF THE INVENTION

It is an object of the present invention to provide an improved confectionery moulding device for use in the home and in which increased throughput and efficiency are achieved.

### DISCLOSURE OF THE INVENTION

There is disclosed herein a confectionery moulding device for making confectionery pieces from a source of flowing confectionery, comprising:
a frame, and
a plurality of trays supported by the frame and positioned one above another, each tray comprising at least one mould cavity, at least some of the trays including a drain via which the flowing confectionery material can pass to a tray therebeneath.

Preferably, each tray comprises a plurality of said cavities interconnected by flow tracks.

Preferably, the device further comprises a vessel supported upon the frame for containing said source of flowing confectionery.

Preferably, the vessel includes a tap via which will be flowing confectionery can pass en route to an uppermost one of the trays.

Preferably, the device further comprises a delivery chute situated under the tap and along which the flowing confectionery material flows en route to the uppermost one of the trays.

Preferably, the vessel includes a motor-driven internal agitator for mixing the flowing confectionery.

Preferably, the device further comprises a lid hinged to the vessel and a motor is mounted upon the lid for driving the agitator.

Preferably, the motor comprises an output sprocket and the agitator comprises an input coupling aligned with the output sprocket.

Preferably, the agitator comprises a pair of wheels interconnected by a plurality of paddles.

Preferably, the device further comprises a heating element in heat-transfer relationship with the vessel to heat the source of flowing confectionery.

### BRIEF DESCRIPTION OF THE DRAWINGS

A preferred form of the present invention will now be described by way of example with reference to the accompanying drawings, wherein:

FIG. 1 is a schematic perspective illustration of a confectionery moulding device,

FIG. 2 is a schematic parts-exploded perspective illustration of the delivery chute and moulding trays of the device of FIG. 1,

FIG. 3 is a schematic parts-exploded perspective illustration of the mixing vessel forming part of the device of FIG. 1,

FIG. 4 is a schematic elevation of the mixing vessel, tap and chute,

FIG. 5 is another schematic elevation of the mixing vessel, tap and chute, and

FIG. 6 is a schematic parts-exploded perspective illustration of the mixing vessel, agitator and lid etc, showing the electric motor and the heating element.

### DESCRIPTION OF THE PREFERRED EMBODIMENT

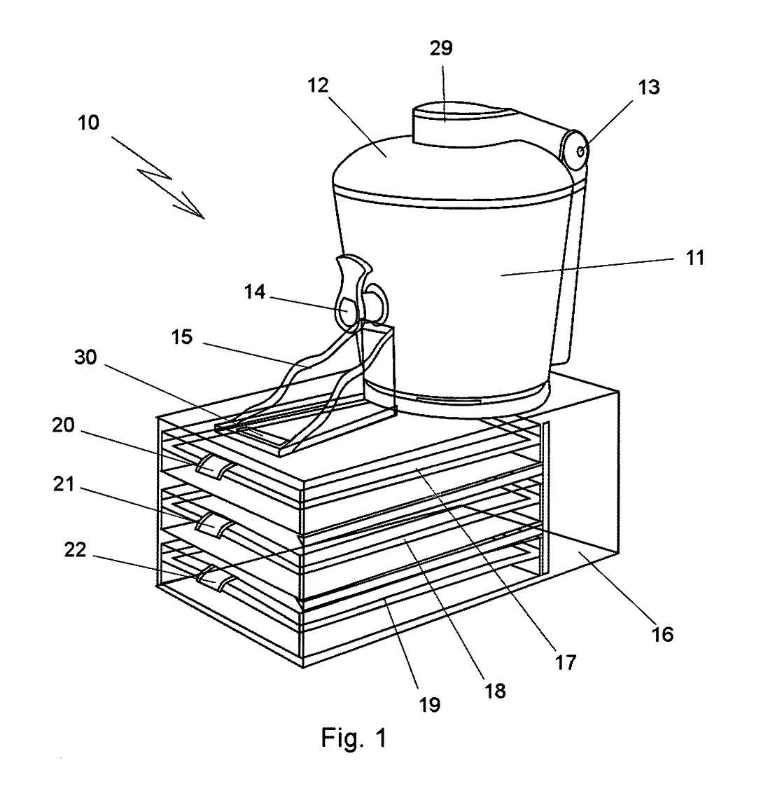

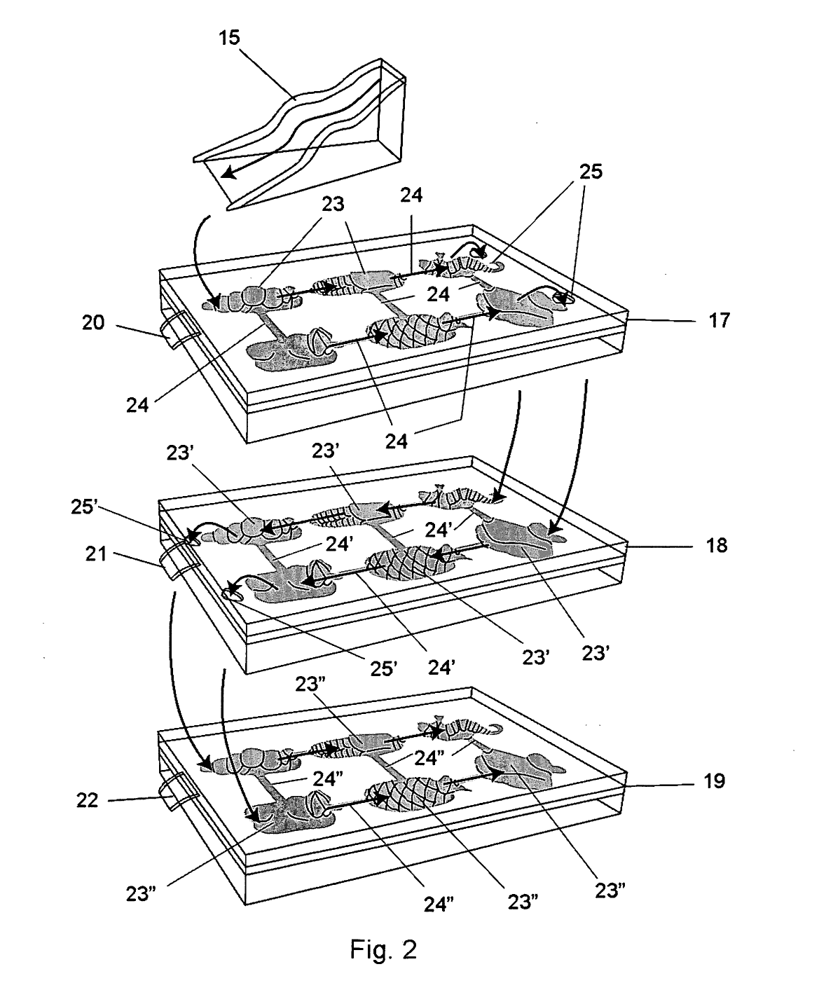

In FIG. 1 there is depicted schematically a confectionery moulding device 10. The device 10 comprises a frame 16 somewhat in the form of a cabinet. Set upon the cabinet 16 is a mixing vessel 11 having a lid 12 hinged at 13 thereto. The vessel 11 includes a tap 14 that is manually activated by hand.

Situated upon the frame 16 is a chute 15 having its upper end beneath the tap 14. The delivery chute includes a slot 30 at its bottom end through which material having passed along the chute from the tap falls.

Within the cabinet 16 are three trays 17, 18 and 19. These slide in and out of the cabinet like drawers and to this end are provided with handles 20, 21 and 22 respectively.

The top tray 17 comprises a plurality of mould cavities 23 which are interconnected by flow tracks 24. Flowing confectionery material having passed through the slot 30 enters one of the mould cavities 23 from which it migrates to the other mould cavities 23 via the various flow tracks 24. At the back of the top tray, there is provided a pair of drain holes 25 through which excess flowing confectionery material falls to the middle tray therebeneath.

The middle tray 18 comprises a plurality of mould cavities 23′ which are interconnected by flow tracks 24′. Flowing confectionery material having passed through the holes 25 of the top tray enters two of the mould cavities 23′ from which it migrates to the other mould cavities 23′ via the various flow tracks 24′. At the front of the middle tray 18, there is provided a pair of drain holes 25′ through which excess flowing confectionery material falls to the bottom tray 19 therebeneath.

The bottom tray 19 comprises a plurality of mould cavities 23″ which are interconnected by flow tracks 24″. Flowing confectionery material having passed through the holes 25′ of the middle tray enters two of the mould cavities 23″ from which it migrates to the other mould cavities 23″ via the various flow tracks 24″.

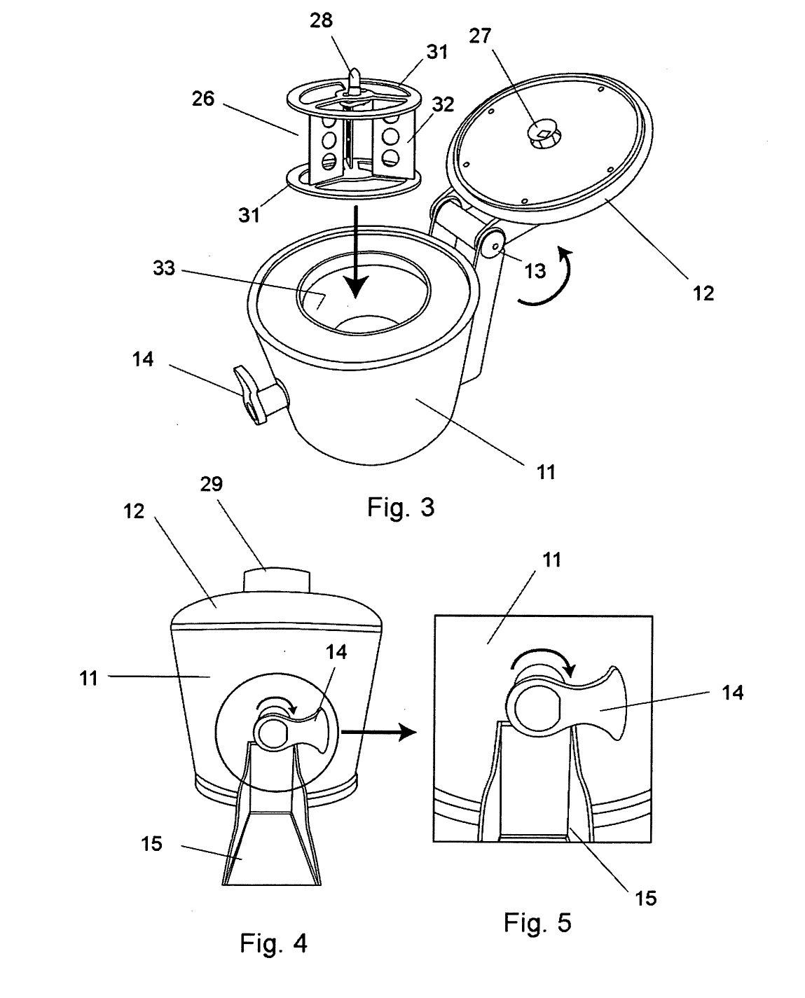

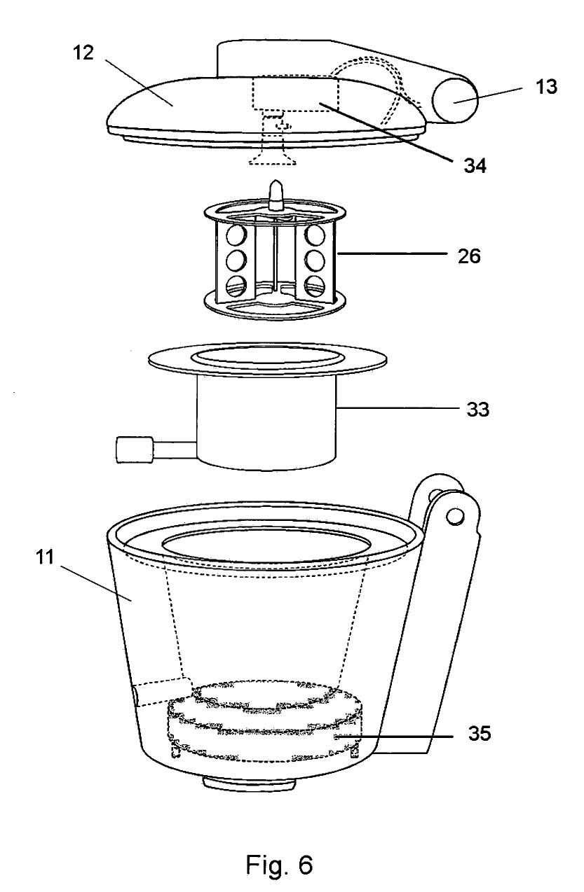

The mixing vessel 11 as shown in FIG. 3 has an internal agitator 26 comprising upper and lower wheels 31 interconnected by three perforated paddles 32. The agitator 28 is sized to fit snugly within a cylindrical lining 33 of the vessel. There may be provided between the floor of this lining 33 and the outer wall of the vessel 11 a heating element 35 to apply heat through the lining 33 to the confectionery material to keep it soft and flowing. At the top of the agitator 26, there is provided an input coupling 28. The lid 12 comprises a motor housing 29 within which there is located an electric/magnetic motor 34 having an output sprocket 27. Where the input coupling 28 is square in cross-section, the sprocket 27 would have a mating square hollow to receive the coupling to transmit torque thereto. The sprocket 27 is appropriately spaced from the hinge 13 so that when the lid 12 is closed, the sprocket 27 aligns properly with and engages direct upon the input coupling 28. Upon activation of the motor 34, the agitator spins whilst being constrained laterally by the lining 33 to mix the flowing confectionery material within the vessel.

In use, preheated confectionery material is poured into the vessel 11 either before or after insertion of the agitator 26 therein. Where a heater is provided within the vessel 11, the confectionery material may be added to the vessel in granular form for example. The heater would then be switch-activated to melt the granular confectionery material and/or maintain the flowing state of the confectionery material within the vessel 11. The same switch (not shown) or an additional switch (not shown) is activated to start the motor 34 which in turn causes motion of the agitator 26. When desired, the tap 14 is turned as shown in FIGS. 4 and 5 so that flowing material passes along the chute 15 and along the flow path described above. After a certain cooling time, the trays can be opened like drawers using handles 21, 22 and 23 and set confectionery can be removed. As an alternative, instead of waiting for the confectionery to set, the trays can be withdrawn and placed in a refrigerator for example.

It should be appreciated that modifications and alterations obvious to those skilled in the art are not to be considered as beyond the scope of the present invention. For example, flow tubes might be provided to deliver flowing material directly to the lower trays instead of in cascade fashion from the upper trays.

1. A confectionery moulding device for making confectionery pieces from a source of flowing confectionery, comprising:
a frame, and
a plurality of trays supported by the frame and positioned one above another, each tray comprising at least one cavity, at least some of the trays including a drain via which the flowing confectionery material can pass to a tray therebeneath.

2. The device of claim 1, comprising a plurality of said cavities interconnected by flow tracks.

3. The device of claim 1, further comprising a vessel supported upon the frame for containing said source of flowing confectionery.

4. The device of claim 3, wherein the vessel includes a tap via which will be flowing confectionery can pass en route to an uppermost one of the trays.

5. The device of claim 4, further comprising a delivery chute situated under the tap and along which the flowing confectionery material flows en route to the uppermost one of the trays.

6. The device of claim 3, wherein the vessel includes a motor-driven internal agitator for mixing the flowing confectionery.

7. The device of claim 6, further comprising a lid hinged to the vessel and a motor mounted upon the lid for driving the agitator.

8. The device of claim 6, wherein the motor comprises an output sprocket and wherein the agitator comprises an input coupling aligned with the output sprocket.

9. The device of claim 6, wherein the agitator comprises a pair of wheels interconnected by a plurality of paddles.

10. The device of claim 3, further comprising a heating element in heat-transfer relationship with the vessel to heat the source of flowing confectionery.
